(19) United States
(12) Patent Application Publication
(10) Pub. No.: US 2006/0120824 A1
(43) Pub. Date: Jun. 8, 2006

(54) Method and system for acoustic fastening

(76) Inventors: Andrew P. Miehl, Plantation, FL (US); Shlomo Gelbart, Plantation, FL (US); Aaron M. Schuelke, Coral Springs, FL (US)

Correspondence Address: MOTOROLA, INC;INTELLECTUAL PROPERTY SECTION, LAW DEPT, 8000 WEST SUNRISE BLVD, FT LAUDERDAL, FL, 33322, US

(21) Appl. No.: 10/994,587

(22) Filed: Nov. 19, 2004

(51) Int. Cl. F16B 21/00; F16B 19/00

(52) U.S. Cl. 411/339; 411/510; 411/907; 411/913

(57) ABSTRACT

The invention concerns a method (400) and system (100) for acoustic fastening. The system can include a first housing component (118), a second housing component (120) and one or more fasteners (114) having an acoustic channel (116) that passes through the fasteners. The fasteners can at least assist in securing the first housing component to the second housing component. The acoustic channel can be an acoustic leak path (136) that permits the release of acoustic pressure. The acoustic leak path can also decreases a frequency response difference between a sealed design and a leaky design. The acoustic channel may also be part of an acoustic resonator (142) that increases over a range of frequencies a frequency response (720) of an acoustic signal generated by a transducer (126).

### BACKGROUND OF THE INVENTION

1. Field of the Invention

This invention relates in general to fasteners and more particularly to fasteners that facilitate the operation of electronic devices that produce acoustic signals.

2. Description of the Related Art

In today's marketplace, there are numerous electronic devices from which consumers can choose. For example, there are several major communications companies that provide wireless telephone service in the world, each of which offers for sale many different portable communication devices, such as cellular telephones and personal digital assistants. Virtually all these mobile units produce acoustic signals, some of which are used to convey voice traffic to a user.

For example, most cellular telephones include audio transducers for producing audio that are fitted within the housing of the telephone. Users typically cup such telephones over their outer ear to allow them to hear the generated audio. Most cellular telephone manufacturers will incorporate an audio port that runs from one side of a cellular telephone to another. One end of this audio port, sometimes referred to as a leaky port, is normally positioned in the area where a user will place his or her outer ear against the telephone. The other end of the leaky port is open to the environment. As a result, the equalization in air pressure will prevent the user's ear from being accidentally sealed to the telephone.

The most efficient leaky port is one that follows a relatively straight path, with little or no turns. Unfortunately, the leaky port, because it must pass through the entire telephone (or at least one-half of a flip telephone), moves around many components. The leaky port also takes up valuable space in the telephone. Finally, the use of a leaky port may negatively affect the frequency response of an acoustic signal, particularly at certain frequencies, which reduces overall performance.

### SUMMARY OF THE INVENTION

The present invention concerns an acoustic fastening system. The system can include a first housing component, a second housing component; and one or more fasteners that can have an acoustic channel that can pass through the fasteners. The fasteners can at least assist in securing the first housing component to the second housing component.

In one arrangement, the acoustic channel can be part of an acoustic leak path that permits the release of acoustic pressure. The acoustic leak path may also decrease a frequency response difference between a sealed design and a leaky design. In another arrangement, the system can further include a transducer and a sealed volume into which the acoustic channel can empty. The acoustic channel and the sealed volume can be an acoustic resonator that can increase over a range of frequencies a frequency response of an acoustic signal generated by the transducer. The acoustic channel can also have a length and a diameter. Varying at least one of the length and the diameter of the fastener can alter the range of frequencies over which the frequency response of the acoustic signal is increased.

As an example, the fastener can be either a screw or a rivet. Additionally, the first housing component, the second housing component and the fasteners can be part of a mobile communications unit. In one particular example, the system can include at least two fasteners, each one having an acoustic channel in which the acoustic channel for one of the fasteners can be part of an acoustic leak port and the acoustic channel for another fastener can be part of an acoustic resonator. As another example, the first housing component can have at least one opening, and the second housing component can have at least one opening that corresponds to the openings in the first housing component. Also, the openings for the first housing component and the second housing component can receive the fasteners when the fasteners secure the first housing component to the second housing component.

The present invention also concerns an acoustic fastener. The acoustic fastener can include a body portion and an acoustic channel in which the acoustic channel can pass through the body portion. The acoustic fastener can at least assist in the securing of a first housing component to a second housing component. When the acoustic fastener secures the first housing component to the second housing component, the acoustic channel can be at least one of part of an acoustic leak path that permits the release of pressure and part of an acoustic resonator that increases over a range of frequencies a frequency response of an acoustic signal.

The present invention also concerns a method of acoustic fastening. The method can include the steps of generating an acoustic signal from a transducer in an electronic device and porting the acoustic signal through an acoustic channel in an acoustic fastener. The acoustic fastener can at least partially secure together a first housing component and a second housing component of the electronic device.

In one arrangement, the acoustic channel can be part of an acoustic leak path, and the porting the acoustic signal through the acoustic channel step can include releasing an acoustic pressure through the acoustic leak path. In this configuration, the method can also include the step of reducing a frequency response difference between a sealed design and a leaky design.

In another arrangement, the acoustic channel can empty into a sealed volume thereby forming an acoustic resonator, and the porting the acoustic signal through the acoustic channel step can cause a frequency response of the acoustic signal to increase over a range of frequencies. In addition, the acoustic channel can have a length and a diameter, and the method can further include the step of varying at least one of the length and the diameter of the acoustic fastener to adjust the range of frequencies over which the frequency response of the acoustic signal is increased.

### BRIEF DESCRIPTION OF THE DRAWINGS

The features of the present invention, which are believed to be novel, are set forth with particularity in the appended claims. The invention, together with further objects and advantages thereof, may best be understood by reference to the following description, taken in conjunction with the accompanying drawings, in the several figures of which like reference numerals identify like elements, and in which:

FIG. 1 illustrates an example of an acoustic fastening system implemented in a mobile communications unit in accordance with an embodiment of the inventive arrangements;

FIG. 2 illustrates an exploded view of the acoustic fastening system of FIG. 1 in accordance with an embodiment of the inventive arrangements;

FIG. 3 illustrates a cross-sectional view looking along line 1-1 of FIG. 1 in accordance with an embodiment of the inventive arrangements;

FIG. 4 illustrates a method of acoustic fastening in accordance with an embodiment of the inventive arrangements;

FIG. 5 illustrates a graph showing the frequency response of an acoustic signal in accordance with an embodiment of the inventive arrangements;

FIG. 6 illustrates another graph showing the frequency response of an acoustic signal in accordance with an embodiment of the inventive arrangements; and

FIG. 7 illustrates yet another graph showing the frequency response of an acoustic signal in accordance with an embodiment of the inventive arrangements.

### DETAILED DESCRIPTION

While the specification concludes with claims defining the features of the invention that are regarded as novel, it is believed that the invention will be better understood from a consideration of the following description in conjunction with the drawing figures, in which like reference numerals are carried forward.

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

The terms a or an, as used herein, are defined as one or more than one. The term plurality, as used herein, is defined as two or more than two. The term another, as used herein, is defined as at least a second or more. The terms including and/or having, as used herein, are defined as comprising (i.e., open language). The term coupled, as used herein, is defined as connected, although not necessarily directly, and not necessarily mechanically. The terms program, software application, and the like as used herein, are defined as a sequence of instructions designed for execution on a computer system. A program, computer program, or software application may include a subroutine, a function, a procedure, an object method, an object implementation, an executable application, an applet, a servlet, a source code, an object code, a shared library/dynamic load library and/or other sequence of instructions designed for execution on a computer system.

This invention presents a method and system for acoustic fastening. In one arrangement, the system can include a first housing component, a second housing component and one or more fasteners. The fasteners have an acoustic channel that passes through the fastener, and the fasteners can at least assist in securing the first housing component to the second housing component. As an example, the acoustic channel can be an acoustic leak path that permits the release of acoustic pressure. As another example, the system can include a transducer and a sealed volume into which the acoustic channel empties. Here, the acoustic channel can be an acoustic resonator that increases over a range of frequencies a frequency response of an acoustic signal generated by the transducer. In one particular embodiment and without limitation, the system components recited above can be part of a mobile communications unit.

Referring to FIG. 1, a portion of an acoustic fastening system 100 is shown. In one arrangement, the acoustic fastening system 100 can be part of a mobile communications unit 112, such as a cellular telephone, two-way radio, personal digital assistant, etc. Although the mobile communications unit 112 is pictured as a flip-type cellular telephone, it is important to note that the invention is not so limited. In fact, the acoustic fastening system 100 can be part of any device that outputs an acoustic signal.

As shown, the acoustic fastening system 100 can include one or more fasteners 114. These fasteners 114, as will be described below, can be used to at least partially secure together one or more components of the mobile communications unit 112. In addition, the fasteners 114 can include acoustic channels 116. An acoustic channel can be defined as any port that can direct acoustic signals in any suitable direction. In addition, an acoustic signal can be any signal that causes the physical displacement or oscillation of air or some other suitable medium.

The acoustic channels 116 can be used to improve the acoustical characteristics of the mobile communications unit 112. For example, the acoustic channel 116 may be part of an acoustic leak path (not shown here), which can permit the release of acoustic pressure. Alternatively, the acoustic channel 116 can be part of an acoustic resonator (also not shown here), which can improve the frequency response of an acoustic signal that is generated by the mobile communications unit 112.

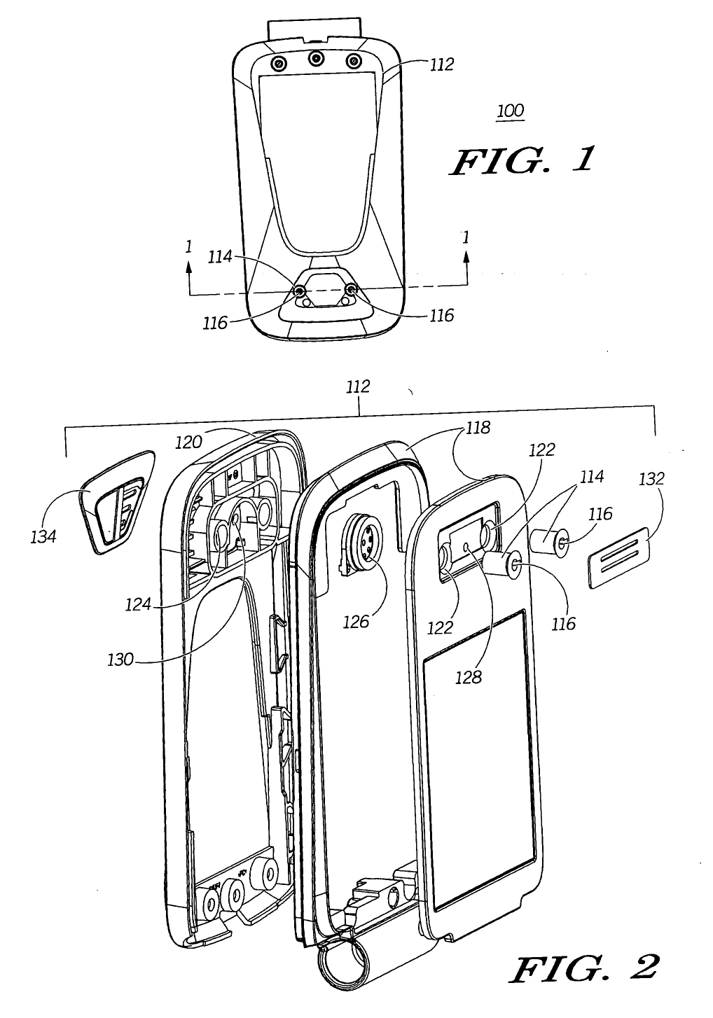

Referring to FIG. 2, an exploded view of the mobile communications unit 112 is shown. In one arrangement, the mobile communications unit 112 can include a first housing component 118 (which actually may consist of two separate pieces) and a second housing component 120. The first housing component 118 and the second housing component 120 can form a flip portion of a flip-type cellular telephone. The first housing component 118 can include one or more openings 122, and the second housing component 120 can have one or more openings 124 that correspond to the openings 122. The first housing component 118 can be coupled to the second housing component 120, and when so done, the openings 122 of the first housing component 118 can line up with the openings 124 of the second housing component 120.

The openings 122, 124 can receive the fasteners 114, and these fasteners 114, as noted earlier, can at least partially assist in securing the first housing component 118 to the second housing component 120. The fasteners 114 can be any device that can be used to help secure together any suitable number of components, like a screw or a rivet. Although not shown, the openings 122, 124 can include any suitable structure for assisting the fasteners 114 in securing the first housing component 118 to the second housing component 120. The acoustic channels 116 for the fasteners 114 are also shown here.

The system 100 can also include a transducer 126, which can be sandwiched between the first housing component 118 and the second housing component 120. As an example, the transducer 126 can be an audio transducer. As is known in the art, the transducer 126 can generate acoustic signals, which can be broadcast through a primary port 128 in the first housing component 118. The second housing component 120 can also include a back port 130, which, as is also known in the art, can allow for proper operation of the transducer 126.

The system 100 can also include a first grill 132 that can be adhered to the first housing component 118 and a second grill 134 that can be adhered to the second housing component 120. The first and second grills 132, 134 can protect certain components of the mobile communications unit 112 from dirt or other foreign particles and can also improve the aesthetics of the unit 112. While not shown here, those of skill in the art will appreciate that the system 100 may contain other components to enable the mobile communications unit 112 to operate, such as acoustic seals.

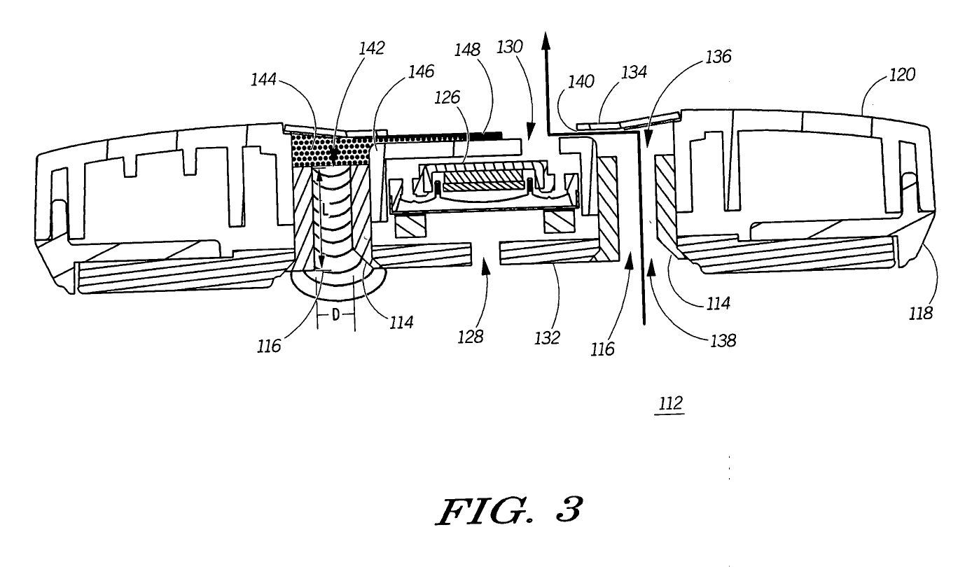

Referring to FIG. 3, a cut-away view of the mobile communications unit 112 looking along lines 1-1 of FIG. 1 is shown. Here, the first housing component 118 is shown coupled and secured to the second housing component 120. The transducer 126 is also shown positioned between the first housing component 118 and the second housing component 120 for outputting acoustic signals through the primary port 128. The back port 130 and the first and second grills 132, 134 are also pictured.

In one arrangement, one of the fasteners 114 can help form an acoustic leak path 136. Specifically, the acoustic channel 116 of one of the fasteners 114 can help create the acoustic leak path 136. In accordance with an embodiment of the inventive arrangements, the acoustic leak path 136 can permit the release of acoustic pressure. That is, at least a portion of an acoustic signal can enter a first opening 138 of the acoustic leak path 136 and can be directed to a second opening 140 of the acoustic leak path 136. The arrow shown in the acoustic leak path 136 can represent the path that the acoustic signal may follow. The second opening 140 of the acoustic leak path 140 can connect the acoustic leak path 136 to the outside environment. As a result, the release of acoustic pressure may occur when a user has his or her ear positioned against the first component housing 118. As can be also seen, the acoustic leak path 136 is generally straight and can present a direct path for the acoustic signal to follow.

In another arrangement, one of the fasteners 114 can help create an acoustic resonator 142. In particular, the acoustic channel 116 can help form the acoustic resonator 142. The acoustic channel 116 that helps form the acoustic resonator 142 can have a length L and a diameter D, both of which can be given any suitable value. The system 100 can also include a sealed volume 144, which is represented by the plurality of dots, and the acoustic channel 116 can empty into the sealed volume 144. The sealed volume 144 can be formed by the second housing component 120, a transducer seal 146 that houses the transducer 126 and an acoustic seal 148. As those of skill in the art will appreciate, the acoustic channel 116 and the sealed volume 144 can form the acoustic resonator 142. The waves shown emanating from the acoustic resonator 142 represent the resonating effect that occurs in this configuration.

The acoustic resonator 142 can increase the frequency response of an acoustic signal that enters the appropriate acoustic channel 116. As will be explained later, this frequency response can occur over a range of frequencies. As will also be explained later, varying the length L or the diameter D of the acoustic channel 116 can vary the range of frequencies over which the frequency response of the acoustic signal will be increased.

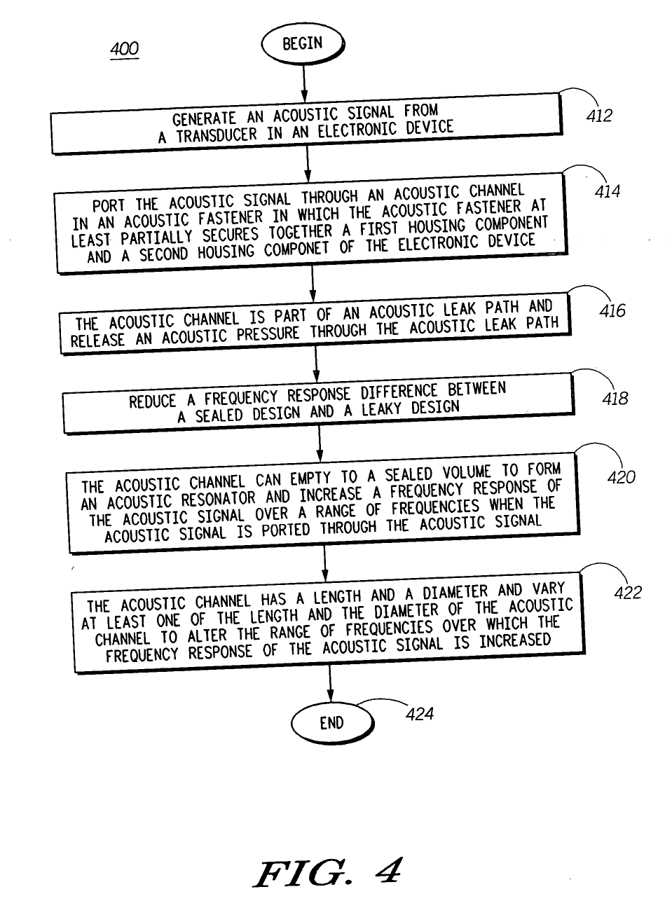

Referring to FIG. 4, a method 400 is shown for acoustic fastening. Although reference will be made to FIGS. 2 and 3 to help describe the method 400, it is understood that the method 400 can be practiced or implemented in any other suitable system or device. Moreover, the method 400 is not limited to the order of the steps as depicted in FIG. 4, and the method 400 can be practiced with a greater or lower number of steps than those recited.

At step 410, the method 400 can begin. At step 412, an acoustic signal can be generated from a transducer in an electronic device. At step 414, the acoustic signal can be ported through an acoustic channel in an acoustic fastener in which the acoustic fastener at least partially secures together a first housing component and a second housing component of the electronic device. As an example, at step 416, the acoustic channel can be part of an acoustic leak path, and the porting the acoustic signal through the acoustic channel step can include releasing an acoustic pressure through the acoustic leak path. In addition, at step 418, a frequency response difference between a sealed design and a leaky design can be reduced.

For example, referring to FIGS. 1-3, an acoustic signal can be generated from the acoustic transducer 126, which, as explained above, can be part of the mobile communications unit 112. This acoustic signal can be ported through the acoustic channel 116 in the acoustic fastener 114, and, as described above, the acoustic fastener 114 can at least partially secure together the first housing component 118 and the second housing component 120 of the mobile communications unit 112. As also explained above, the acoustic channel 116 can be part of an acoustic leak path 136 that releases an acoustic pressure, which can prevent a user from accidentally sealing the mobile communications unit 112 to his or her ear.

The acoustic leak path 136 can also help reduce a frequency response difference between a sealed design and a leaky design. For example, referring to FIG. 5, a graph 500 is shown that depicts two frequency response curves in which sound pressure level (SPL) in decibels (dB) is plotted against frequency in hertz (HZ). A first frequency response curve 510 can represent the frequency response of an acoustic signal that is broadcast from, for example, a mobile communications unit in which a sealed coupler or sealed ear simulator is positioned against a speaker of the mobile communications unit that is outputting the acoustic signal. This configuration can be referred to as a sealed design.

The second frequency response curve 520 can represent the frequency response of an acoustic signal that is broadcast from a mobile communications unit in which a leaky coupler or leaky ear simulator is placed against the speaker. This configuration may be referred to as a leaky design, and it more accurately reflects the actual acoustical experience that occurs when a person uses the mobile communications unit. In this graph, the mobile communications unit can have a conventional leak path, i.e., no acoustically tuned fasteners are present.

As those of skill in the art will appreciate, it is desirable to create a mobile communications unit design that lowers the amplitude of the sealed frequency response curve 510 to reduce as much as possible the difference between it and the leaky frequency response curve 520. As can be seen, however, substantial differences between the amplitude of the sealed frequency response curve 510 and the leaky frequency response curve 520 are present. In fact, the average difference is roughly 10.8 dB.

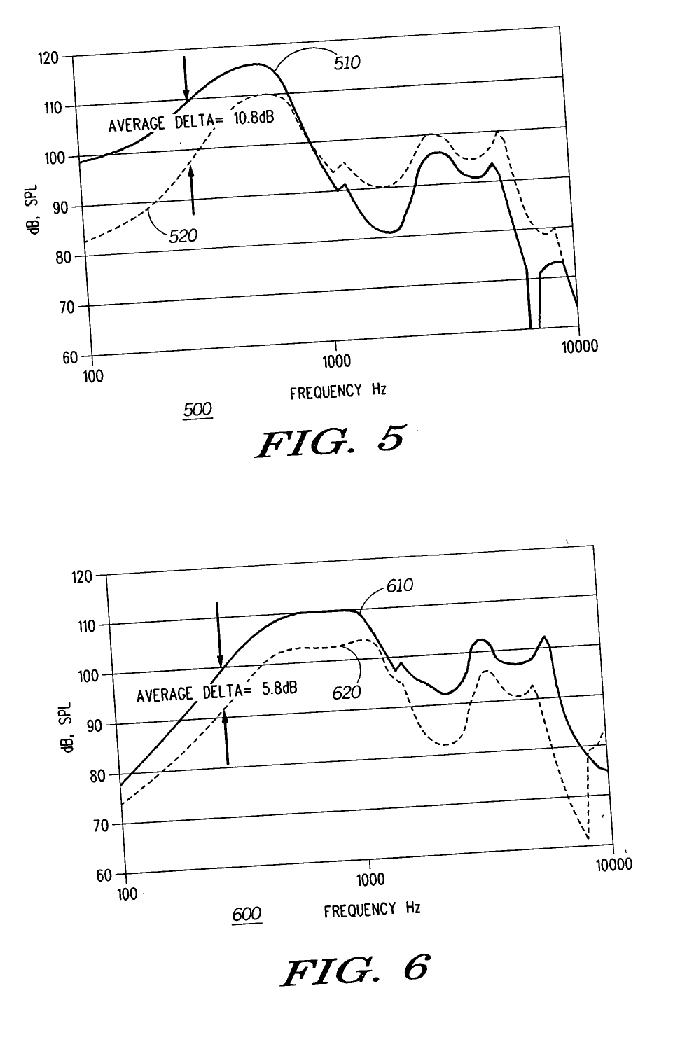

Referring to FIG. 6, another graph 600 is shown in which a sealed frequency response curve 610 and a leaky frequency response curve 620 are illustrated. Here, the sealed frequency response curve 610 can represent the frequency response of an acoustic signal transmitted from a mobile communications unit having one or more acoustic fasteners 114 (see FIGS.1-3) that serve as leak ports when a sealed coupler is positioned against the speaker of the mobile communications unit. Again, this configuration may be referred to as a sealed design. Additionally, the leaky frequency response curve 620 can signify the frequency response of the acoustic signal when a leaky coupler is positioned over the speaker of the mobile communications unit having the acoustic fasteners 114, which can be referred to as a leaky design. As pictured, the amplitude of the sealed frequency response curve 610 has moved towards the amplitude of the leaky frequency curve 620. In this example, the average difference has dropped from 10.8 dB seen in graph 500 of FIG. 5 to approximately 5.8 dB.

Referring back to the method 400 of FIG. 4, at step 420, the acoustic channel can empty into a sealed volume and can form an acoustic resonator, and the porting the acoustic signal through the acoustic channel step can cause a frequency response of the acoustic signal to increase over a range of frequencies. At step 422, the acoustic channel can have a length and a diameter and at least one of the length and the diameter of the acoustic channel can be varied to alter the range of frequencies over which the frequency response of the acoustic signal is increased. At step 424, the method 400 can end.

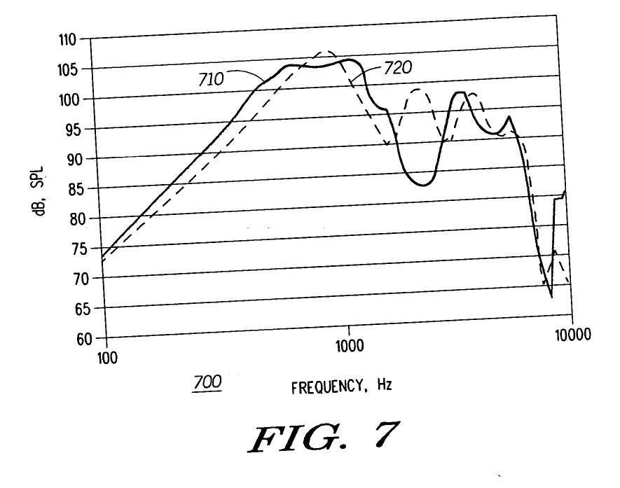

For example, as mentioned above, the acoustic fastener 114, referring to FIG. 3, can empty into a sealed volume 144, which can, along with the acoustic channel 116, form an acoustic resonator 142. The acoustic resonator 142 can boost over certain frequencies the frequency response of an acoustic signal broadcast from the transducer 126. Referring to FIGS. 3 and 7, a graph 700 shows a first frequency response curve 710 and a second frequency response curve 720. The first frequency response curve 710 can represent the frequency response of an acoustic signal that is broadcast from a mobile communications unit having two acoustic leak paths 136 but no acoustic resonator 142. The second frequency response curve 720 can represent the frequency response of the acoustic signal broadcast from the mobile communications unit when the mobile communications unit has an acoustic leak path 136 and an acoustic resonator 142.

As shown, the first frequency response curve 710 may have a distinct drop in dB between 2 kHz and 3 kHz, for example. In contrast, however, the second frequency response curve 720, which is associated with the acoustic resonator 142, may show an increase over these frequencies, which can improve performance. Moreover, as those of skill in the art may appreciate, the range of frequencies over which this increase may occur can be modified or varied if the length L and/or the diameter D of the acoustic channel 116 are altered.

Although in the drawings the invention has been shown to have one acoustic leak path 136 and one acoustic resonator 142, it must be noted that the invention is not so limited. In particular, the invention can include any suitable number and type of fasteners having an acoustic channel. As an example, the invention can include any suitable number of acoustic leak paths 136 and any suitable number of acoustic resonators 142 and any suitable combination thereof. Further, it is important to note that the inventive system is not limited to being implemented in a mobile communications unit, as the inventive arrangements can be part of any suitable electronic device. It is also understood that the invention is in no way limited to operation in the frequencies or amplitudes shown in the graphs 500, 600 or 700, as other suitable values may apply.

In addition, where applicable, the present invention can be realized in hardware, software or a combination of hardware and software. Any kind of computer system or other apparatus adapted for carrying out the methods described herein are suitable. A typical combination of hardware and software can be a mobile communication device with a computer program that, when being loaded and executed, can control the mobile communication device such that it carries out the methods described herein. The present invention can also be embedded in a computer program product, which comprises all the features enabling the implementation of the methods described herein and which when loaded in a computer system, is able to carry out these methods.

While the preferred embodiments of the invention have been illustrated and described, it will be clear that the invention is not so limited. Numerous modifications, changes, variations, substitutions and equivalents will occur to those skilled in the art without departing from the spirit and scope of the present invention as defined by the appended claims.

What is claimed is:

1. An acoustic fastening system, comprising:
a first housing component;
a second housing component; and
one or more fasteners having an acoustic channel that passes through the fastener, wherein the fasteners at least assist in securing the first housing component to the second housing component.

2. The system according to claim 1, wherein the acoustic channel is part of an acoustic leak path that permits the release of acoustic pressure.

3. The system according to claim 1, wherein the acoustic channel is part of an acoustic leak path, wherein the acoustic leak path decreases a frequency response difference between a sealed design and a leaky design.

4. The system according to claim 1, further comprising a transducer and a sealed volume into which the acoustic channel empties, wherein the acoustic channel and the sealed volume are an acoustic resonator that increases over a range of frequencies a frequency response of an acoustic signal generated by the transducer.

5. The system according to claim 4, wherein the acoustic channel has a length and a diameter and varying at least one of the length and the diameter of the acoustic channel alters the range of frequencies over which the frequency response of the acoustic signal is increased.

6. The system according to claim 1, wherein the fastener is at least one of a screw and a rivet.

7. The system according to claim 1, wherein the first housing component, the second housing component and the fasteners are part of a mobile communications unit.

8. The system according to claim 1, wherein the system includes at least two fasteners, each one having an acoustic channel, wherein the acoustic channel for one of the fasteners is part of an acoustic leak port and the acoustic channel for another fastener is part of an acoustic resonator.

9. The system according to claim 1, wherein the first housing component has at least one opening and the second housing component has at least one opening that corresponds to the openings in the first housing component and wherein the openings for the first housing component and the second housing component receive the fasteners when the fasteners secure the first housing component to the second housing component.

10. An acoustic fastener, comprising:
a body portion;
an acoustic channel, wherein the acoustic channel passes through the body portion;
wherein the acoustic fastener at least assists in the securing of a first housing component to a second housing component;
wherein when the acoustic fastener secures the first housing component to the second housing component, the acoustic channel is at least one of part of an acoustic leak path that permits the release of pressure and part of an acoustic resonator that increases over a range of frequencies a frequency response of an acoustic signal.

11. The acoustic fastener according to claim 10, wherein the acoustic leak path decreases a frequency response difference between a sealed design and a leaky design.

12. The acoustic fastener according to claim 10, wherein the acoustic channel has a length and a diameter and varying at least one of the length and the diameter alters the range of frequencies over which the frequency response of the acoustic signal is increased.

13. The acoustic fastener according to claim 10, wherein the acoustic fastener is at least one of a screw and a rivet.

14. A method of acoustic fastening, comprising the steps of:
generating an acoustic signal from a transducer in an electronic device; and
porting the acoustic signal through an acoustic channel in an acoustic fastener, wherein the acoustic fastener at least partially secures together a first housing component and a second housing component of the electronic device.

15. The method according to claim 14, wherein the acoustic channel is part of an acoustic leak path and the porting the acoustic signal through the acoustic channel step comprises releasing an acoustic pressure through the acoustic leak path.

16. The method according to claim 14, wherein the acoustic channel is part of an acoustic leak path and the method further comprises the step of reducing a frequency response difference between a sealed design and a leaky design.

17. The method according to claim 14, wherein the acoustic channel empties into a sealed volume thereby forming an acoustic resonator and the porting the acoustic signal through the acoustic channel step causes a frequency response of the acoustic signal to increase over a range of frequencies.

18. The method according to claim 17, wherein the acoustic channel has a length and a diameter and the method further comprises the step of varying at least one of the length and the diameter of the acoustic channel to alter the range of frequencies over which the frequency response of the acoustic signal is increased.

19. The method according to claim 14, wherein the acoustic fastener is at least one of a screw and a rivet.

20. The method according to claim 14, wherein the electronic device is a mobile communications unit.
